(19) United States
(12) Patent Application Publication
(10) Pub. No.: US 2004/0211031 A1
(43) Pub. Date: Oct. 28, 2004

(54) Scuff protector

(76) Inventor: Lisa Marie Cox, El Cajon, CA (US)

Correspondence Address: Lisa M. Cox, 1142 Dawnridge Avenue, El Cajon, CA, 92021, US

(21) Appl. No.: 10/420,727

(22) Filed: Apr. 23, 2003

(51) Int. Cl. B60B 33/00

(52) U.S. Cl. 16/18 CG; 16/18 R

(57) ABSTRACT

Currently, office chairs wheels are covered by a hard plastic plate. When someone rolls an office chair with wheels into a different direction and accidentally hits their shoes with the wheel covers, a scuff or tear results. Because the Scuff Protector is a protective covering, covered with heavy fabric or carpet type of material for wheel covers, it will pad the collision and prevent this from happening.

The Scuff Protector is a product designed to protect shoes from scuff marks or tears when they are rolled into by office chairs with wheels. The Scuff Protector is a plastic molded piece which is covered with a thick fabric/carpet type of material. The Scuff Protector will mount on the wheel cover of an office chair. The Scuff Protector will prevent scuffs or tears in shoes which occur when shoes are hit by the wheel cover of an office chair when a person rolls the chair into a different position.

### BACKGROUND

The field of endeavor to which the Scuff Protector pertains to is a professional office environment. The Scuff Protector is a plastic molded piece which is covered with a thick fabric/carpet type of material. The Scuff Protector will mount on the wheel cover of an office chair. The Scuff Protector will prevent scuffs or tears in shoes which occur when shoes are hit by the wheel cover of an office chair when a person rolls the chair into a different position. Currently, the wheels of an office chair are covered by an uncovered hard, plastic plate. When a person rolls an office chair, they will often times roll it into the back of their shoe, causing a scuff or tear. The Scuff Protector prevents this from happening.

### BRIEF SUMMARY

The Scuff Protector is a product designed to protect shoes from scuff marks or tears when they are hit by an office chair with wheels. Currently, the wheels of an office chair are covered by an uncovered hard, plastic plate. When a person rolls an office chair, they will often times roll it into the back of their shoe, causing a scuff or tear. The Scuff Protector prevents this from happening. The Scuff Protector is a plastic molded piece which is covered with a thick fabric/carpet type of material. The Scuff Protector will mount on the wheel cover of an office chair. The Scuff Protector will prevent scuffs or tears in shoes which occur when shoes are hit by the wheel cover of an office chair when a person rolls the chair into a different position.

### BRIEF DESCRIPTION OF VIEWS OF THE DRAWING

FIG. 1 is an enlarged drawing of the Scuff Protector with illustrations of the protective fabric, as well as the mounts.

FIG. 2 is an illustration of how the Scuff Protector will mount on a typical office chair.

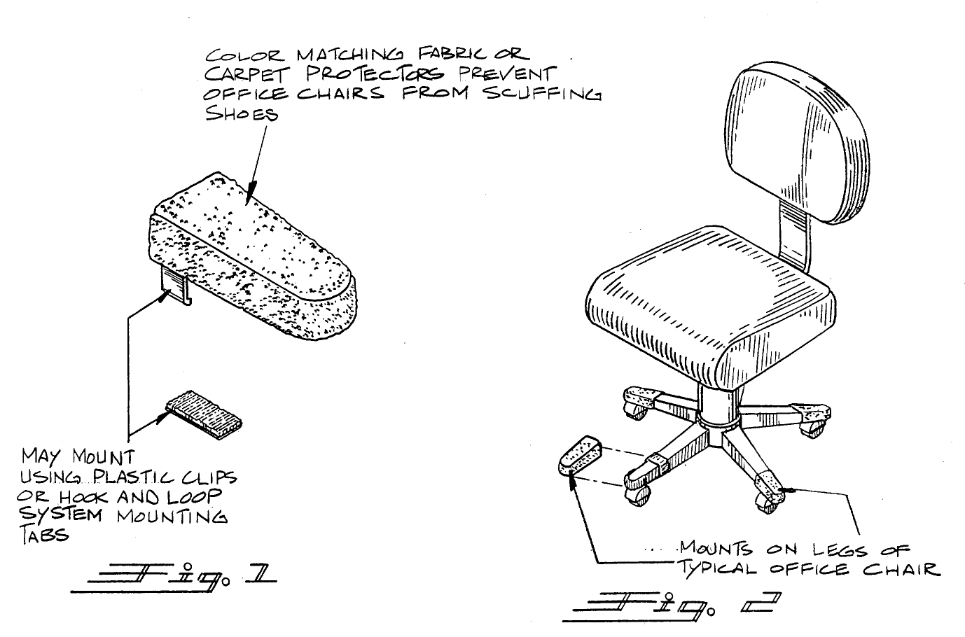

### DETAILED DESCRIPTION

I plan on contracting a plastic mold manufacturer to develop the plastic mold from which the Scuff Protector will be poured. Most office chairs have a standard wheel cover; however, as there are a variety of chairs on the market, there will have to be some variations on the size of the mold. The main component of the Scuff Protector will be plastic. Once the mold is cast and the Scuff Protector produced, a piece of very thick fabric or carpet type of material will be glued onto it. The Scuff Protector will mount on the wheel cover of an office chair using plastic clips or by a hook and loop system mounting tabs. I will package and sell the Scuff Protector directly to stores, i.e. office supply/furniture stores, Walmart, etc. I also plan on contacting various office chair manufacturers and licensing the Scuff Protector to them.

1. I claim the Scuff Protector will allow you move an office chair with wheels and if your shoe is hit by the wheel cover of the office chair, the Scuff Protector will prevent any resulting scuffs or tears from the collision.
